(19) United States
(12) Patent Application Publication
(10) Pub. No.: US 2015/0043191 A1
(43) Pub. Date: Feb. 12, 2015

(54) LIGHTING APPARATUS WITH ZOOMING FUNCTION

(71) Applicant: Osram GmbH, Muenchen (DE)

(72) Inventors: Hong Deng, Kunshan Jiangsu (CN); Henning Rehn, Berlin (DE)

(21) Appl. No.: 14/333,526

(22) Filed: Jul. 17, 2014

(30) Foreign Application Priority Data
Aug. 8, 2013 (CN) 201310344175.X

(51) Int. Cl. G03B 15/06

(52) U.S. Cl. CPC G03B 15/06
USPC 362/17; 362/16

(57) ABSTRACT

A lighting apparatus includes a reflector which has a truncated cone shape along a central axis of the lighting apparatus and a base which is coupled to a narrow end face of the reflector and is capable of moving toward a wide end face of the reflector along the central axis of the lighting apparatus. The lighting apparatus further includes a light source which is mounted centrally on an end face of the base.

### CROSS-REFERENCE TO RELATED APPLICATION

This application claims priority to Chinese Patent Application Serial No. 201310344175.X, which was filed Aug. 8, 2013, and is incorporated herein by reference in its entirety.

### TECHNICAL FIELD

Various embodiments relate generally to the technical field of lighting, and e.g. to a lighting apparatus with a zooming function, and e.g. to a lighting apparatus with a zooming function which is capable of improving lighting efficiency.

### BACKGROUND

A lighting apparatus with a zooming function such as so called “pepper light” has been broadly used in stage illumination or studio illumination. The zooming function refers to a function of adjusting the beam angle and therefore the illumination area. Many solutions for implementing the lighting apparatus with the zooming function are known. However, such solutions have disadvantages of low efficiency, high heat generation, non-uniform zooming, etc.

### SUMMARY

A lighting apparatus includes a reflector which has a truncated cone shape along a central axis of the lighting apparatus and a base which is coupled to a narrow end face of the reflector and is capable of moving toward a wide end face of the reflector along the central axis of the lighting apparatus. The lighting apparatus further includes a light source which is mounted centrally on an end face of the base.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1a shows a schematic diagram of a conventional lighting apparatus with a zooming function, which is lighting at a large beam angle;

FIG. 1b shows a schematic diagram of the conventional lighting apparatus with the zooming function, which is lighting at a small beam angle;

FIG. 2a shows a schematic diagram of a lighting apparatus according to various embodiments, which is lighting at a large beam angle;

FIG. 2b shows a schematic diagram of the lighting apparatus according to various embodiments, which is lighting at a small beam angle;

FIG. 3 shows a schematic diagram of a lighting apparatus according to various embodiments, which is lighting at a small beam angle;

FIGS. 4a and 4b show a perspective diagram of the reflector of the lighting apparatus according to various embodiments and a sectional diagram thereof along a central axis of the lighting apparatus, respectively;

FIGS. 5a and 5b show a perspective diagram of the reflector of the lighting apparatus according to various embodiments and a sectional diagram thereof along a central axis of the lighting apparatus, respectively;

FIGS. 6a and 6b show a schematic diagram of a relative position of a light source to a reflector of the lighting apparatus according to various embodiments and a schematic diagram of the obtained illumination area, respectively;

FIGS. 7a and 7b show a schematic diagram of a relative position of a light source to a reflector of the lighting apparatus according to various embodiments and a schematic diagram of the obtained illumination area, respectively;

FIGS. 8a and 8b show a schematic diagram of a relative position of a light source to a reflector of the lighting apparatus according to various embodiments and a schematic diagram of the obtained illumination area, respectively; and

FIGS. 9a and 9b show a schematic diagram of a relative position of a light source to a reflector of the lighting apparatus according to various embodiments and a schematic diagram of the obtained illumination area, respectively.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The embodiments will be described hereinafter in combination with the accompanying drawings. In view of clarity and conciseness, not all of the features of a practical embodiment are described in the description. However, it should be understood that many embodiment-specific decisions are to be made in the development of any practical embodiment, in order to achieve particular objects of the developers; and those decisions may be changed with the variation of the embodiments.

It should be further pointed out that, only those structures closely related to the present disclosure are shown in the drawings, and those having little relations to the disclosure are omitted, so as not to obscure the disclosure with unnecessary details.

A lighting apparatus with a zooming function according to the present disclosure will be described in detail with the help of the accompanying drawings. It will be appreciated that the disclosure is not limited to the specific implementation described below with reference to the drawings.

Various embodiments provide a lighting apparatus with a zooming function which can reduce or even remove at least one of the disadvantages of the conventional lighting apparatuses as described above.

In various embodiments, a lighting apparatus with a zooming function is provided. The lighting apparatus includes a reflector which has a truncated cone shape along a central axis of the lighting apparatus, a base which is coupled to a narrow end face of the reflector and is capable of moving toward a wide end face of the reflector along the central axis of the lighting apparatus, and a light source which is mounted at an end face of the base centrally.

The lighting apparatus according to various embodiments has an uniform zooming function and has at least advantages of high lighting efficiency and low heat generation.

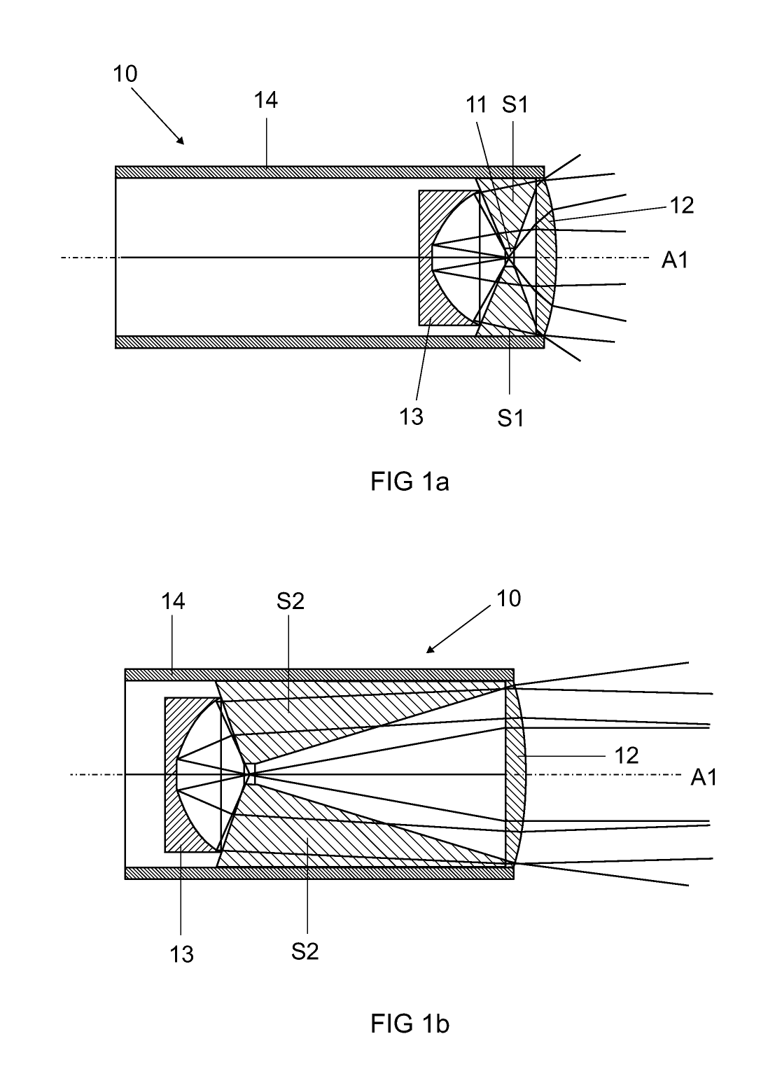

FIG. 1a and FIG. 1b are schematic diagrams of a conventional lighting apparatus 10 with a zooming function, which is lighting at a large beam angle and at a small beam angle, respectively.

The lighting apparatus 10 with the zooming function as shown in FIG. 1a and FIG. 1b is a lighting apparatus known as “pepper light” which has been broadly used in stage illumination and studio illumination. The lighting apparatus 10 typically includes a light source 11, a front lens 12, a reflector 13, and a housing 14.

As shown in FIG. 1a and FIG. 1b, the housing 14 of the lighting apparatus 10 has a cylinder shape. The light source 10 and the reflector 13 are housed in the housing 14 and are arranged along a central axis A1 of the housing 14. The light source 10 and the reflector 13 may move along the central axis A1 of the housing 14 in the housing 14. The front lens 12 is mounted on an end of housing 14.

The light source 11 is typically a halogen bulb. The front lens 12 may be a plate lens or a convex lens according to specific requirement. In FIG. 1a and FIG. 1b the front lens 12 is a convex lens. The reflector 13 is used for reflecting the light emitted by the light source 11 toward the front lens 12.

Herein the zooming function of the lighting apparatus 10 is achieved by changing the distance between the light source 11 and the front lens 12.

As shown in FIG. 1a, when the light source 11 is close to the front lens 12, the light emitted by the lighting apparatus 10 has a beam angle up to +/−40°. The term “beam angle” used herein indicates an angle formed by two directions with a light intensity of 50% of the maximum light intensity in a section along a central axis of beam emitted by a lighting apparatus. Generally, the direction along the central axis has the maximum light intensity, and the beam angle may be an angle of outer edge of a light cone formed by the light with a light intensity of 50% of the maximum light intensity relative to the central axis. Most portion of the light emitted by the light source 11 may be emitted outside through the front lens 12. As shown in FIG. 1a, the light passing through the front lens 12 consists of two portions, one portion is light emitted directly by the light source 11, and the other portion is light emitted by the light source 11 after being reflected by the reflector 13. As indicated by the reference symbol “S1” in FIG. 1a, a small portion of light emitted by the light source 11 is emitted to the housing 14 and is absorbed by the housing 14, and thereby can not be emitted outside through the front lens 12. At this time, a small portion of light emitted by the light source 11 is absorbed by the housing 14, and the lighting apparatus 10 has an efficiency of 80%.

As shown in FIG. 1b, when the light source 11 moves away from the front lens 12, the beam angle of the light emitted by the lighting apparatus 10 is reduced gradually, and thereby a zooming function is achieved. When the distance between the light source 11 and the front lens 12 has reached to the maximum distance allowed by the design, the beam angle of the light emitted by the lighting apparatus 10 may reach to +/−20°. However, as indicated by the reference symbol “S2” in FIG. 1b, a large portion of light emitted by the light source 11 is emitted to the housing 14 and is absorbed by the housing 14, and thereby can not be emitted outside through the front lens 12. At this time, the lighting efficiency of the lighting apparatus 10 is only 50%. In addition, a large portion of light emitted by the light source 11 is absorbed by the housing 14, resulting in temperature rising of the housing 14, and therefore the use safety of the lighting apparatus 10 may be impaired.

The present disclosure provides a novel lighting apparatus with a zooming function, which can overcome the disadvantages of low lighting efficiency, high heat generation, etc.

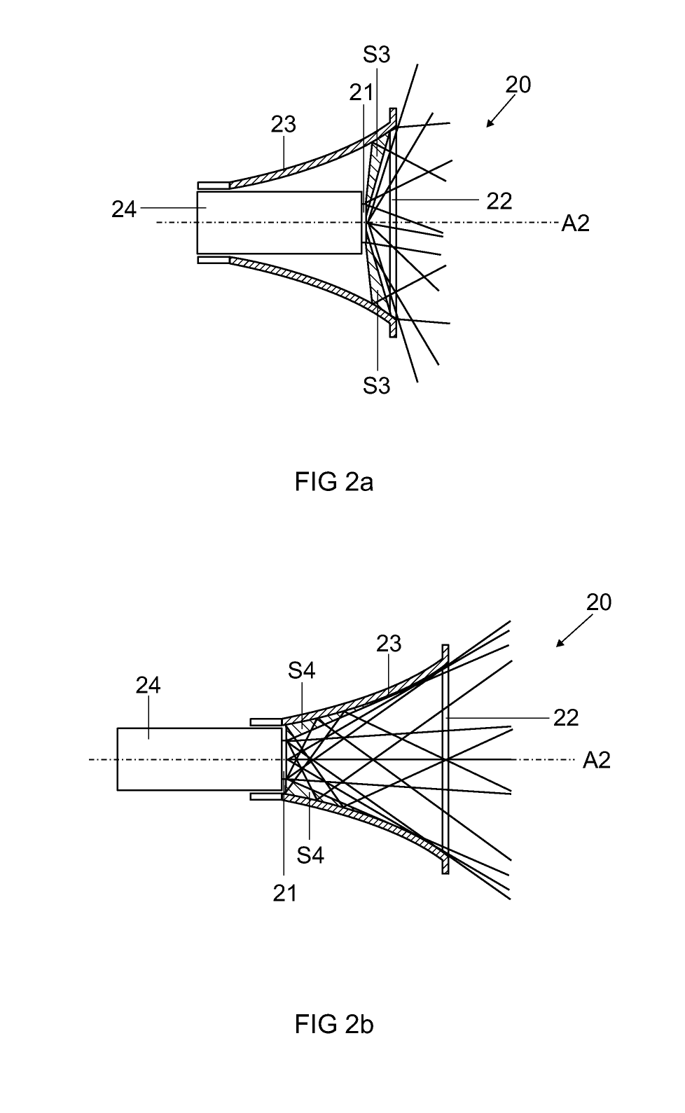

FIG. 2a and FIG. 2b are schematic diagrams of a lighting apparatus 20 according to various embodiments, which is lighting at a large beam angle and at a small beam angle, respectively.

As shown in FIG. 2a and FIG. 2b, the lighting apparatus 20 according to various embodiments includes a light source 21, a front lens 22, a reflector 23, and a base 24.

The light source 21 is a light emitting diode (LED) array which is centrally mounted on an end face of the base 24 as described below. It should be appreciated by those skilled in the art that according to specific application and design requirement, the light source 21 may also be a LED point light source, or may adopt any other lighting component.

The front lens 22 is mounted on a wide end face of the reflector 23 as described below, and the front lens 22 may be a plate lens or a convex lens according to specific requirement. In various embodiments, the front lens 22 is a plate lens made of foggy glass.

In various embodiments, the reflector 23 has a truncated cone shape along a central axis A2 of the lighting apparatus 20. In various embodiments, the reflector 23 has a faceted truncated cone shape along a central axis A2 of the lighting apparatus 20. Namely, the projection of the reflector 23 on a plane which is perpendicular to the central axis A2 of the lighting apparatus 20 has a regular polygon shape similar to circle. In case that the reflector 23 has a smooth truncated cone shape, there may an imaging effect somewhat in the illumination area of the lighting apparatus 20, that is, a profile or a bright spot of the light source 21 may appear in the illumination area. In case that the reflector 23 has a faceted truncated cone shape, the imaging effect can be reduced largely, and thereby the illumination area is more uniform. Theoretically, the more the number of the faces which constitute the periphery of the faceted truncated cone is, the smaller the area of each face is, and the more uniform the illumination area of the lighting apparatus 20 is. However, the number of the faces depends on specific application and machining precision. In addition, as described above, the projection of the reflector 23 on a plane which is perpendicular to the central axis A2 of the lighting apparatus 20 has a regular polygon shape. In various embodiments, the regular polygon does not have a structure which is symmetric circumferentially, that is, the number of the sides of the regular polygon is not a multiple of 2 or 3. This may avoid strengthening the light in some directions, and thereby the light distribution is more uniform.

In addition, as shown in FIG. 2a and FIG. 2b, the reflector 23 may have a trumpet faceted truncated cone shape along the central axis A2 of the lighting apparatus 20. Namely, the projection of the reflector 23 on a plane which is along the central axis A2 of the lighting apparatus 20 has a shape similar to trapezoid, in which two bevel sides of the trapezoid protrude inward. FIG. 4a and FIG. 4b are a perspective diagram of the reflector 23 of the lighting apparatus 20 according to various embodiments and a sectional diagram thereof along the central axis A2 of the lighting apparatus 20, respectively.

The function of the reflector 23 according to various embodiments includes the functions of the reflector 13 and the housing 14 as shown in FIG. 1a and FIG. 1b. The reflector 23 can not only reflect the light emitted by the light source 21, but also function as a housing for receiving and protecting.

The base 24 is provided along the central axis A2 of the lighting apparatus 20 and is coupled to a narrow end face of the reflector 23, and is capable of moving toward the wide end face of the reflector 23 along the central axis A2 of the lighting apparatus 29.

In the embodiment, the base 24 has a cylinder shape along the central axis A2 of the lighting apparatus 20. However, it should be appreciated by those skilled in the art that according to specific application and design requirement, the base 24 may have any other shape, as long as it is capable of moving along the central axis A2 of the lighting apparatus 29.

As shown in FIG. 2a, when the light source 21 is close to the front lens 22, the light emitted by the lighting apparatus 20 has a beam angle up to +/−60°. Most portion of the light emitted by the light source 21 may be emitted outside through the front lens 22. As indicated by the reference symbol “S3” in FIG. 2a, a tiny portion of light emitted by the light source 21 is absorbed by the reflector 23, and thereby can not be emitted outside through the front lens 22. Therefore, at this time, the lighting efficiency of the lighting apparatus 20 is up to 90%.

As shown in FIG. 2b, when the light source 21 moves away from the front lens 22, the beam angle of the light emitted by the lighting apparatus 20 is reduced gradually, and thereby a zooming function is achieved. When the distance between the light source 21 and the front lens 22 has reached to the maximum distance allowed by the design, the beam angle of the light emitted by the lighting apparatus 20 may reach to +/−20°. At this time, as indicated by the reference symbol “S4” in FIG. 2b, a small portion of light emitted by the light source 21 is absorbed by the reflector 23, and thereby can not be emitted outside through the front lens 22. At this time, benefiting the novel shape of the reflector 23, the lighting efficiency of the lighting apparatus 20 can still reach to 80%, which is far higher than 50% of the conventional lighting apparatus. In addition, a small portion of light emitted by the light source 21 is absorbed by the reflector 23, therefore the temperature of the reflector 23 will not be too high, and thereby the safety of the lighting apparatus 20 may be improved.

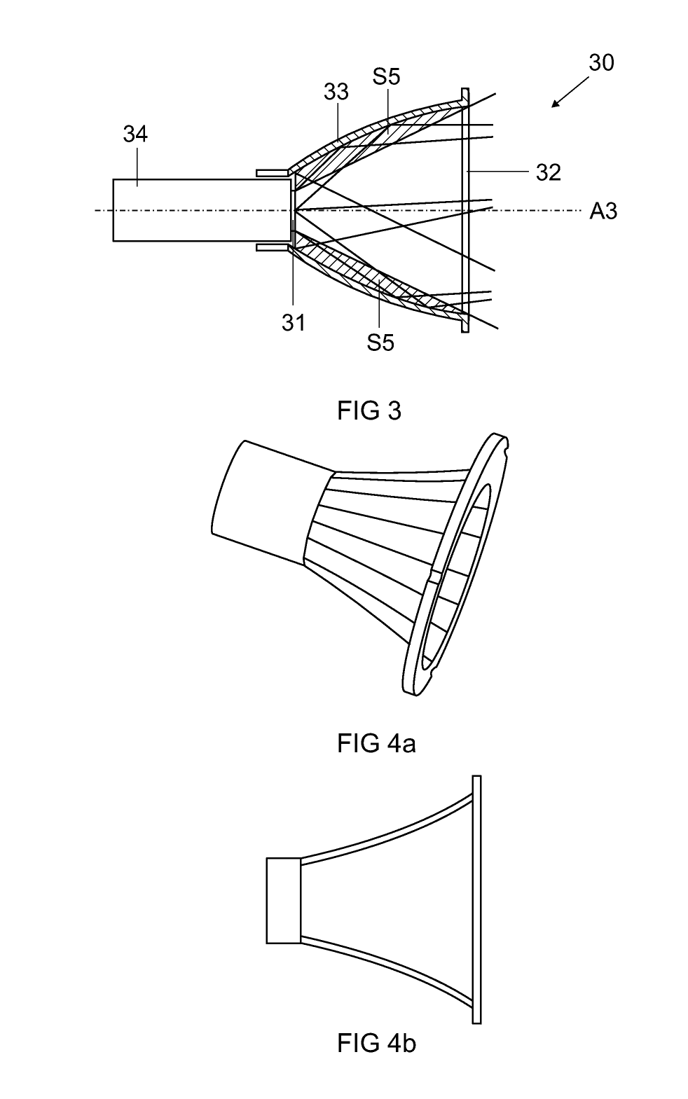

In some cases, there is a need for further reducing the beam angle of the lighting apparatus. At this time, the shape of the reflector may be modified to achieve such object. FIG. 3 is a schematic diagram of a lighting apparatus 30 according to various embodiments, which is lighting at a small beam angle.

The structure of the lighting apparatus 30 according to various embodiments is substantially the same as that of the lighting apparatus 20 according to various embodiments as described above except for that the shape of a reflector 33 of the lighting apparatus 30 is different from the reflector 23 of the lighting apparatus 20. Therefore, the detailed description regarding the other components of the lighting apparatus 30 will not be repeated.

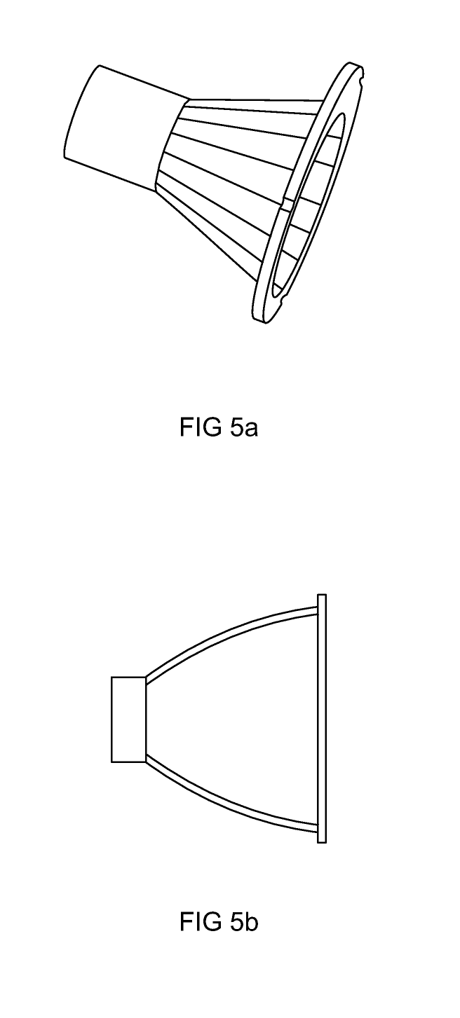

As shown in FIG. 3, the reflector 33 may have a bowl faceted truncated cone shape along the central axis A3 of the lighting apparatus 30. Namely, the projection of the reflector 33 on a plane which is along the central axis A3 of the lighting apparatus 30 has a shape similar to trapezoid, in which two bevel sides of the trapezoid protrude outward. FIG. 5a and FIG. 5b are a perspective diagram of the reflector 33 of the lighting apparatus 30 according to various embodiments and a sectional diagram thereof along the central axis A3 of the lighting apparatus 30, respectively.

When the light source 31 is close to the front lens 32, the lighting of the lighting apparatus 30 is similar to that of the lighting apparatus 20 which has been described above with reference to FIG. 2a, and therefore the description thereof is omitted herein.

As shown in FIG. 3, when the light source 31 moves away from the front lens 32, the beam angle of the light emitted by the lighting apparatus 30 is reduced gradually, and thereby a zooming function is achieved. When the distance between the light source 31 and the front lens 32 has reached to the maximum distance allowed by the design, the beam angle of the light emitted by the lighting apparatus 30 may reach to +/−15°. At this time, as indicated by the reference symbol “S5” in FIG. 3, a small portion of light emitted by the light source 31 is absorbed by the reflector 33, and thereby can not be emitted outside through the front lens 32. At this time, benefiting the novel shape of the reflector 33, the lighting efficiency of the lighting apparatus 30 can still reach to 80%.

Comparing with the lighting apparatus of the prior art, the lighting apparatus according to the embodiments may have at least one of the following effects:
Benefiting from the shape design of the reflector serving as a housing of the lighting apparatus, the light emitted by the light source are less absorbed, and therefore the lighting efficiency of the lighting apparatus according to various embodiments is higher than that of the conventional lighting apparatus, and the heat generation of the lighting apparatus according to various embodiments is low.
Zooming of the lighting apparatus is made to be more uniform by adjusting the shape of the reflector, for example, by modifying the degree how the bevel sides protrude inward or outward.
An uniform light distribution may be achieved at various zooming positions by using the reflector with the faceted truncated cone shape in combination with the plate lens serving as the front lens which is made of foggy glass.

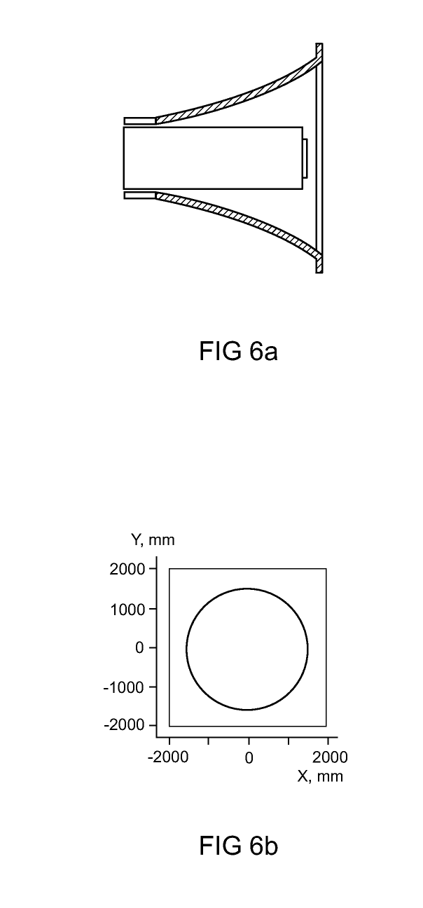

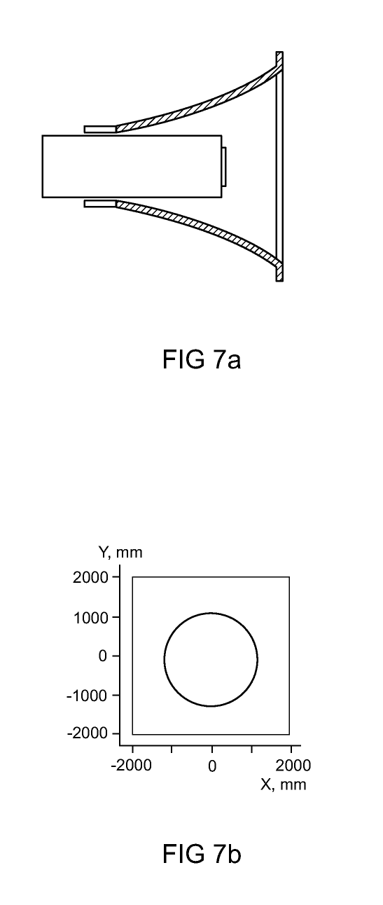

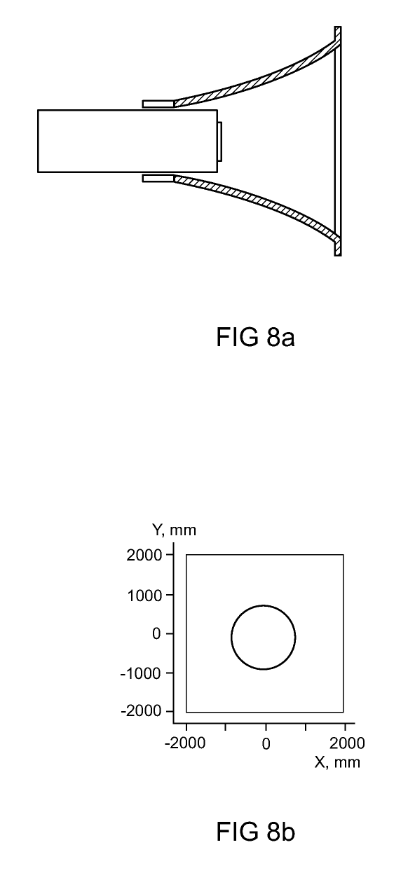

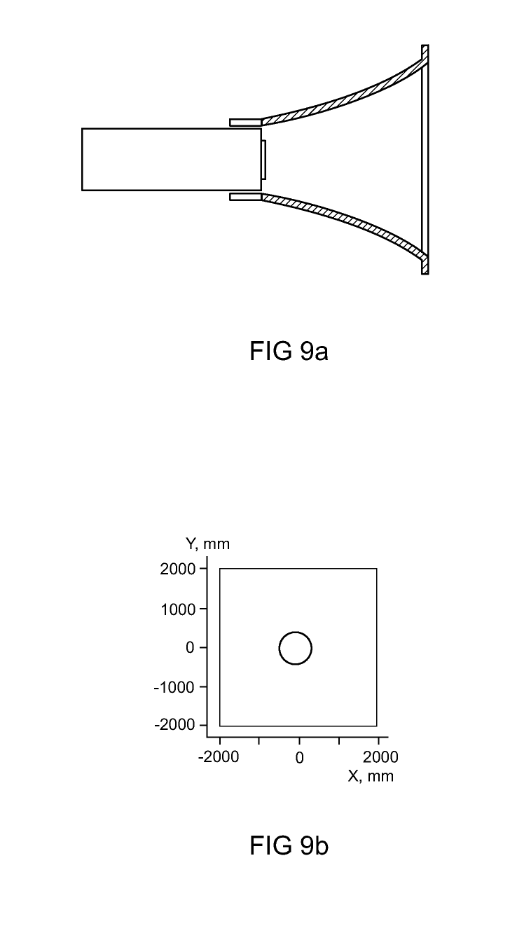

As an example, FIG. 6a, FIG. 6b, FIG. 7a, FIG. 7b, FIG. 8a, FIG. 8b, FIG. 9a, FIG. 9b illustrate different relative positions of the light source to the reflector of the lighting apparatus according to various embodiments and the obtained illumination areas, respectively. The coordinate system shown in FIG. 6b, FIG. 7b, FIG. 8b, FIG. 9b is used for indicating the position coordinate of the illumination area of the lighting apparatus. When the light source is close to the wide end face of the reflector as shown in FIG. 6a, the illumination area of the lighting apparatus is large, as shown in FIG. 6b, and therefore a floodlighting is achieved. When the light source is located at an intermediate position of the reflector close to the wide end face of the reflector as shown in FIG. 7a, the illumination area of the lighting apparatus becomes smaller smoothly as shown in FIG. 7b. When the light source is located at an intermediate position of the reflector close to the narrow end face of the reflector as shown in FIG. 8a, the illumination area of the lighting apparatus continues to become smaller as shown in FIG. 8b, and the light beam is more concentrated. When the light source is close to the narrow end face of the reflector as shown in FIG. 9a, the light emitted by the lighting apparatus is zoomed such that the illumination area of the lighting apparatus is smallest. It can be seen from these figures that the lighting apparatus according to various embodiments has a uniform zooming and a uniform light distribution.

Finally, it should be noted that, the terms “include”, “comprise” and any other variations mean non-exclusive inclusion, so that the process, method, article or device that includes a series of elements includes not only those elements but also other elements that are not explicitly listed, or further includes inherent elements of the process, method, article or device. Moreover, when there is no further limitation, the element defined by the wording “include(s) a . . . ” does not exclude the case that the process, method, article or device that includes the element includes other same elements.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting apparatus with a zooming function, the lighting apparatus comprising:
a reflector which has a truncated cone shape along a central axis of the lighting apparatus;
a base which is coupled to a narrow end face of the reflector and is capable of moving toward a wide end face of the reflector along the central axis of the lighting apparatus; and
a light source which is mounted centrally on an end face of the base.

2. The lighting apparatus of claim 1,
wherein the reflector has a faceted truncated cone shape along the central axis of the lighting apparatus.

3. The lighting apparatus of claim 2,
wherein the projection of the reflector on a plane which is perpendicular to the central axis of the lighting apparatus has a regular polygon shape, and the number of the sides of the regular polygon is not a multiple of 2 or 3.

4. The lighting apparatus of claim 1,
wherein the base has a cylinder shape along the central axis of the lighting apparatus.

5. The lighting apparatus of claim 1, further comprising:
a plate lens which is made of foggy glass and is mounted on the wide end face of the reflector.

6. The lighting apparatus of claim 1,
wherein the reflector has a trumpet faceted truncated cone shape along the central axis of the lighting apparatus so as to achieve a maximum beam angle of +/−60° when the base moves to close to the wide end face of the reflector.

7. The lighting apparatus of claim 1,
wherein the reflector has a bowl faceted truncated cone shape along the central axis of the lighting apparatus so as to achieve a minimum beam angle of +/−15° when the base moves to close to the narrow end face of the reflector.

8. The lighting apparatus of claim 1,
wherein the light source is a light emitting diode.

9. The lighting apparatus of claim 1,
wherein the light source is a light emitting diode array.

10. A lighting apparatus having a central axis, the lighting apparatus comprising:
a reflector having a truncated cone shape along the central axis;
a base coupled to a narrow end face of the reflector;
wherein the base is configured to move toward a wide end face of the reflector along the central axis of the lighting apparatus; and
a light source mounted centrally on an end face of the base.
